(19) United States
(12) Patent Application Publication
(10) Pub. No.: US 2024/0239819 A1
(43) Pub. Date: Jul. 18, 2024

(54) SYNTHESIS OF AMINOALKYL-SUBSTITUTED DISILOXANES

(71) Applicant: GE Infrastructure Technology LLC, Greenville, SC (US)

(72) Inventors: Bryce Martin Lipinski, Melbourne, FL (US); Mark D. Doherty, Niskayuna, NY (US); Michael Joseph O'Brien, Halfmoon, NY (US); Matthew H. Littlejohn, Clifton Park, NY (US)

(21) Appl. No.: 18/529,059

(22) Filed: Dec. 5, 2023

Related U.S. Application Data
(60) Provisional application No. 63/386,231, filed on Dec. 6, 2022.

(51) Int. Cl. C07F 7/08

(52) U.S. Cl. CPC C07F 7/0879; C07F 7/0838

(57) ABSTRACT

Described herein is a method of preparing an aminoalkyl-substituted disiloxane. The method includes forming a mixture including a di- or polyamine containing at least one primary amine group and a silane; reacting the mixture in a first reaction; adding a hydrolysis agent to the mixture; and reacting the mixture in a second reaction to form the aminoalkyl-substituted disiloxane. Also described herein is an aminoalkyl-substituted disiloxane prepared according to the method.

### RELATED APPLICATIONS

This application claims priority to U.S. Provisional Application Ser. No. 63/386,231, filed on Dec. 6, 2022.

### BACKGROUND

The field of the disclosure relates generally to methods of preparing aminoalkyl-substituted disiloxanes and aminoalkyl-substituted disiloxanes produced by same.

Aminoalkyl-substituted disiloxanes are useful for a wide variety of purposes. For example, they are particularly useful in carbon capture systems or aminosilicone-based products.

Substituted disiloxanes are often produced via known reactions. However, known reactions may be limited in scope and may be ineffective for producing aminoalkyl-substituted disiloxanes. For example, the process described in CN102675596 involves a reaction pathway which is not suitable for aminoalkyl-substituted disiloxanes due to side reactions that preferentially form cyclic products. Likewise, the process described in CN102351893 starts from a material that can only hydrolyze to one compound. Further, some processes, like the process described in Li, et. al., Thermochimica Acta, 2012, 545, 75, require multi-step reaction pathways and intermediate purification steps which may require a relatively large number of reaction steps, and/or which may reduce the overall yields and increase the costs and complexity of the process.

Therefore, opportunities for preparing aminoalkyl-substituted disiloxanes are limited. Accordingly, there is a need for simplified methods of preparing aminoalkyl-substituted disiloxanes.

### BRIEF DESCRIPTION

In one aspect, a method of preparing an aminoalkyl-substituted disiloxane is provided. The method includes: I) forming a mixture including: a di- or polyamine containing at least one primary amine group; and a silane; II) reacting the mixture in a first reaction; III) adding a hydrolysis agent to the mixture; and IV) reacting the mixture in a second reaction to form the aminoalkyl-substituted disiloxane.

In another aspect, an aminoalkyl-substituted disiloxane of Formula (I) is provided. The Formula is:

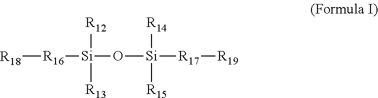

wherein:
R₁₂, R₁₃, R₁₄, R₁₅, are each individually selected from the group consisting of hydrogen, substituted or unsubstituted linear alkyl, substituted or unsubstituted C₁-C₆ linear alkyl, substituted or unsubstituted branched alkyl, substituted or unsubstituted C₃-C₆ branched alkyl, substituted or unsubstituted linear heteroalkyl, substituted or unsubstituted branched heteroalkyl, aryl, phenyl, heteroaryl, methyl, ethyl, propyl, isopropyl, butyl, pentyl, and hexyl;
R₁₆ and R₁₇ are each individually selected from the group consisting of direct bonds, substituted or unsubstituted C₁-C₆ linear alkyl, substituted or unsubstituted C₃-C₆ branched alkyl, C₁ alkyl, C₂ alkyl, C₃ alkyl, C₄ alkyl, C₅ alkyl, and C₆ alkyl; and
R₁₈ and R₁₉ are each individually selected from the group consisting of substituents of Formula (IV)

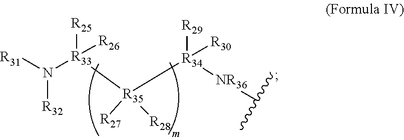

wherein:
the wavy bond indicates a bonding location to Formula (I);
R₂₅, R₂₆, R₂₇, R₂₈, R₂₉, and R₃₀ are each individually selected from the group consisting of hydrogen, substituted or unsubstituted linear alkyl, substituted or unsubstituted C₁-C₆ linear alkyl, substituted or unsubstituted branched alkyl, substituted or unsubstituted C₃-C₆ branched alkyl, substituted or unsubstituted linear heteroalkyl, substituted or unsubstituted C₁-C₆ linear heteroalkyl, substituted or unsubstituted branched heteroalkyl, substituted or unsubstituted C₃-C₆ branched heteroalkyl, aryl, heteroaryl, methyl, ethyl, propyl, isopropyl, butyl, pentyl, and hexyl;
R₃₁ and R₃₂ are each individually selected from the group consisting of hydrogen, substituted or unsubstituted linear alkyl, substituted or unsubstituted C₁-C₆ linear alkyl, substituted or unsubstituted C₁-C₃ linear alkyl, substituted or unsubstituted branched alkyl, substituted or unsubstituted C₃-C₆ branched alkyl, methyl, ethyl, propyl, substituted or unsubstituted cycloalkyl, substituted or unsubstituted C₃-C₆ cycloalkyl, and substituted or unsubstituted C₄-C₆ cycloalkyl, or, when taken together, R₃₁ and R₃₂ form a single ring selected from the group consisting of heterocycloalkyl or heteroaryl;
R₃₃, R₃₄, and R₃₅ are each individually selected from the group consisting of direct bonds, substituted or unsubstituted C₁-C₆ linear alkyl, substituted or unsubstituted C₃-C₆ branched alkyl, C₁ alkyl, C₂ alkyl, C₃ alkyl, C₄ alkyl, C₅ alkyl, C₆ alkyl, ether, —OCH₂CH₂—, —OCH₂CH₂CH₂—, —OCH₂CH₂CH₂CH₂—, —NHCH₂CH₂—, —NHCH₂CH₂CH₂—, and —NHCH₂CH₂CH₂CH₂—;
R₃₆ is selected from the group consisting of hydrogen, substituted or unsubstituted linear alkyl, substituted or unsubstituted C₁-C₆ linear alkyl, substituted or unsubstituted C₁-C₃ linear alkyl, substituted or unsubstituted branched alkyl, substituted or unsubstituted C₃-C₆ branched alkyl, methyl, ethyl, propyl, substituted or unsubstituted cycloalkyl, substituted or unsubstituted C₃-C₆ cycloalkyl, substituted or unsubstituted C₄-C₆ cycloalkyl, heterocycloalkyl, and heteroaryl; and
m is an integer in a range of 0 to 20;
provided that the aminoalkyl-substituted disiloxane is not

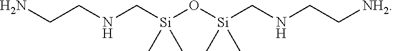 [SMILES: C[Si](C)(CNCCN)O[Si](C)(C)CNCCN]

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is an exemplary method flow chart in accordance with the present disclosure.

Unless otherwise indicated, the drawings provided herein are meant to illustrate features of embodiments of the disclosure. These features are believed to be applicable in a wide variety of systems comprising one or more embodiments of the disclosure. As such, the drawings are not meant to include all conventional features known by those of ordinary skill in the art to be required for the practice of the embodiments disclosed herein.

### DETAILED DESCRIPTION

The embodiments described herein overcome at least some of the disadvantages of known methods of preparing aminoalkyl-substituted disiloxanes and known aminoalkyl-substituted disiloxanes. The exemplary embodiments described herein include a method of preparing an aminoalkyl-substituted disiloxane, wherein the method includes: I) forming a mixture including: a di- or polyamine containing at least one primary amine group; and a silane; II) reacting the mixture in a first reaction; III) adding a hydrolysis agent to the mixture; and IV) reacting the mixture in a second reaction to form the aminoalkyl-substituted disiloxane. The exemplary embodiments described herein avoid side reactions and/or produce the desired product in fewer steps and with superior yields and purity, as compared to known methods of preparing an aminoalkyl-substituted disiloxane.

In many embodiments, the method is a one-pot synthesis. As used herein, a one-pot synthesis is a synthesis that occurs in a single reaction vessel. It is not necessary to remove intermediates from the reaction vessel for separation and/or purification. The one-pot synthesis may include one reaction or more than one reaction. One-pot syntheses are particularly advantageous in reducing reaction complexity and avoiding lengthy and costly separations and purifications.

In many embodiments, the aminoalkyl-substituted disiloxanes are amino-C₁-C₆ alkyl substituted disiloxanes. Embodiments including C₁-C₆ alkyl groups are thermodynamically favorable to form compared to other compounds including larger aminoalkyl substituents or alternative substituents. In some embodiments, the aminoalkyl-substituted disiloxanes are aminomethyl-substituted disiloxanes.

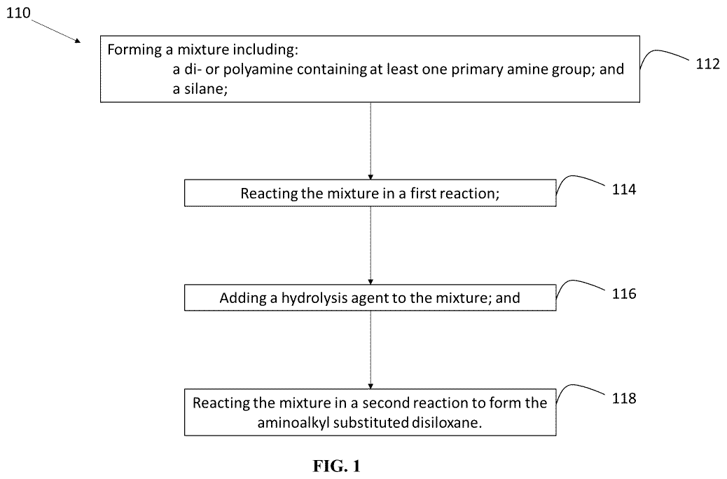

FIG. 1 is an exemplary method flow chart 110. In this exemplary embodiment, method flow chart 110 depicts the essential method steps of the exemplary embodiments described herein and is not intended to limit the method embodiments. Initially, a mixture is formed 112 that includes: a di- or polyamine containing at least one primary amine group; and a silane. The mixture is reacted 114 in a first reaction, and a hydrolysis agent is added 116 to the mixture. The mixture is then reacted 118 in a second reaction to form the aminoalkyl-substituted disiloxane.

In some embodiments, the aminoalkyl-substituted disiloxanes in accordance with the present disclosure are selected from the group consisting of aminoalkyl-substituted disiloxanes of Formula (I)

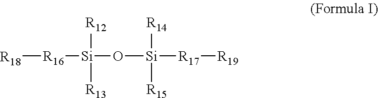

wherein:
R₁₂, R₁₃, R₁₄, R₁₅, are each individually selected from the group consisting of hydrogen, substituted or unsubstituted linear alkyl, substituted or unsubstituted C₁-C₆ linear alkyl, substituted or unsubstituted branched alkyl, substituted or unsubstituted C₃-C₆ branched alkyl, substituted or unsubstituted linear heteroalkyl, substituted or unsubstituted branched heteroalkyl, aryl, phenyl, heteroaryl, methyl, ethyl, propyl, isopropyl, butyl, pentyl, and hexyl;
R₁₆ and R₁₇ are each individually selected from the group consisting of direct bonds, substituted or unsubstituted C₁-C₆ linear alkyl, substituted or unsubstituted C₃-C₆ branched alkyl, C₁ alkyl, C₂ alkyl, C₃ alkyl, C₄ alkyl, C₅ alkyl, and C₆ alkyl, preferably C₁-C₆ linear alkyl, even more preferably C₁ alkyl;
R₁₈ and R₁₉ are each individually selected from the group consisting of substituents of Formula (IV)

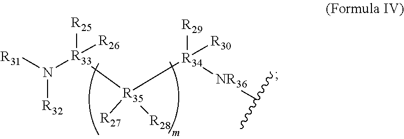

wherein:
the wavy bond indicates a bonding location to Formula (I);
R₂₅, R₂₆, R₂₇, R₂₈, R₂₉, and R₃₀ are each individually selected from the group consisting of hydrogen, substituted or unsubstituted linear alkyl, substituted or unsubstituted C₁-C₆ linear alkyl, substituted or unsubstituted branched alkyl, substituted or unsubstituted C₃-C₆ branched alkyl, substituted or unsubstituted linear heteroalkyl, substituted or unsubstituted C₁-C₆ linear heteroalkyl, substituted or unsubstituted branched heteroalkyl, substituted or unsubstituted C₃-C₆ branched heteroalkyl, aryl, heteroaryl, methyl, ethyl, propyl, isopropyl, butyl, pentyl, and hexyl;
R₃₁ and R₃₂ are each individually selected from the group consisting of hydrogen, substituted or unsubstituted linear alkyl, substituted or unsubstituted C₁-C₆ linear alkyl, substituted or unsubstituted C₁-C₃ linear alkyl, substituted or unsubstituted branched alkyl, substituted or unsubstituted C₃-C₆ branched alkyl, methyl, ethyl, propyl, substituted or unsubstituted cycloalkyl, substituted or unsubstituted C₃-C₆ cycloalkyl, and substituted or unsubstituted C₄-C₆ cycloalkyl, or, when taken together, R₃₁ and R₃₂ form a single ring selected from the group consisting of heterocycloalkyl or heteroaryl;
R₃₃, R₃₄, and R₃₅ are each individually selected from the group consisting of direct bonds, substituted or unsubstituted C₁-C₆ linear alkyl, substituted or unsubstituted C₃-C₆ branched alkyl, C₁ alkyl, C₂ alkyl, C₃ alkyl, C₄ alkyl, C₅ alkyl, C₆ alkyl, ether, —OCH₂CH₂—, —OCH₂CH₂CH₂—, —OCH₂CH₂CH₂CH₂—, —NHCH₂CH₂—, —NHCH₂CH₂CH₂—, and —NHCH₂CH₂CH₂CH₂—;
R₃₆ is selected from the group consisting of hydrogen, substituted or unsubstituted linear alkyl, substituted or unsubstituted C₁-C₆ linear alkyl, substituted or unsubstituted C₁-C₃ linear alkyl, substituted or unsubstituted branched alkyl, substituted or unsubstituted C₃-C₆ branched alkyl, methyl, ethyl, propyl, substituted or unsubstituted cycloalkyl, substituted or unsubstituted C₃-C₆ cycloalkyl, substituted or unsubstituted C₄-C₆ cycloalkyl, heterocycloalkyl, and heteroaryl; and
m is an integer in a range of 0 to 20, preferably in a range of 0 to 10, even more preferably in a range of 0 to 3;
provided that the aminoalkyl-substituted disiloxane is not

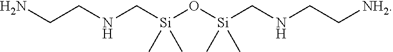 [SMILES: C[Si](C)(CNCCN)O[Si](C)(C)CNCCN]

In some embodiments, the aminoalkyl-substituted disiloxanes are selected from the group consisting of

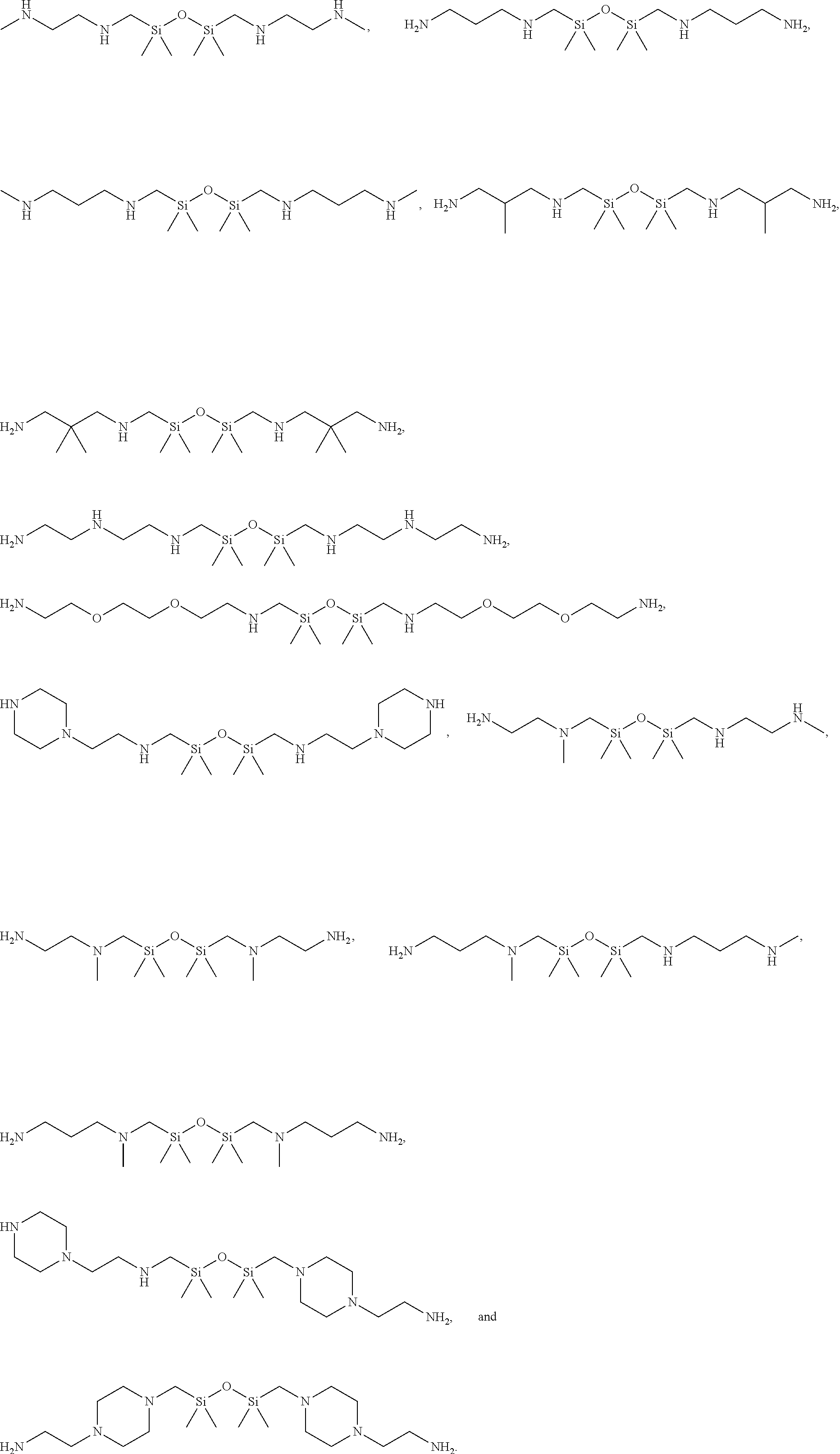

In some embodiments, the di- or polyamine containing at least one primary amine group may be any suitable di- or polyamine containing at least one primary amine group known in the art that facilitates the method described herein. In other embodiments, the di- or polyamine containing at least one primary amine group is a compound of Formula (II)

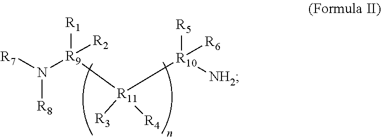

wherein:
R₁, R₂, R₃, R₄, R₅, and R₆ are each individually selected from the group consisting of hydrogen, substituted or unsubstituted linear alkyl, substituted or unsubstituted C₁-C₆ linear alkyl, substituted or unsubstituted branched alkyl, substituted or unsubstituted C₃-C₆ branched alkyl, substituted or unsubstituted linear heteroalkyl, substituted or unsubstituted branched heteroalkyl, substituted or unsubstituted C₃-C₆ branched heteroalkyl, aryl, phenyl, heteroaryl, methyl, ethyl, propyl, isopropyl, butyl, pentyl, and hexyl;
R₇ and R₈ are each individually selected from the group consisting of hydrogen, substituted or unsubstituted linear alkyl, substituted or unsubstituted C₁-C₆ linear alkyl, substituted or unsubstituted C₁-C₃ linear alkyl, substituted or unsubstituted branched alkyl, substituted or unsubstituted C₃-C₆ branched alkyl, methyl, ethyl, propyl, substituted or unsubstituted cycloalkyl, substituted or unsubstituted C₃-C₆ cycloalkyl, and substituted or unsubstituted C₄-C₆ cycloalkyl, or, when taken together, R₇ and R₈ form a single ring selected from the group consisting of heterocycloalkyl or heteroaryl;
R₉, R₁₀, and R₁₁ are each individually selected from the group consisting of direct bonds, substituted or unsubstituted C₁-C₆ linear alkyl, substituted or unsubstituted C₃-C₆ branched alkyl, C₁ alkyl, C₂ alkyl, C₃ alkyl, C₄ alkyl, C₅ alkyl, C₆ alkyl, ether, —OCH₂CH₂—, —OCH₂CH₂CH₂—, —OCH₂CH₂CH₂CH₂—, —NHCH₂CH₂—, —NHCH₂CH₂CH₂—, and —NHCH₂CH₂CH₂CH₂—; and
n is an integer in a range of 0 to 20, preferably in a range of 0 to 10, even more preferably in a range of 0 to 3.

In some embodiments, the silane may be any suitable silane known in the art that facilitates the method described herein. In some embodiments, the silane is an alkoxysilane. In at least some embodiments, the silane is a compound of Formula (III)

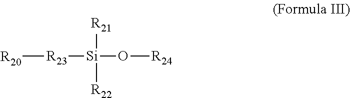

wherein:
R₂₀ is selected from the group consisting of halide, fluoride, chloride, bromide, and iodide;
R₂₁ and R₂₂ are each individually selected from the group consisting of hydrogen, substituted or unsubstituted linear alkyl, substituted or unsubstituted C₁-C₆ linear alkyl, substituted or unsubstituted branched alkyl, substituted or unsubstituted C₃-C₆ branched alkyl, substituted or unsubstituted linear heteroalkyl, substituted or unsubstituted branched heteroalkyl, aryl, phenyl, heteroaryl, methyl, ethyl, propyl, isopropyl, butyl, pentyl, and hexyl;
R₂₃ and R₂₄ are each individually selected from the group consisting of substituted or unsubstituted C₁-C₆ linear alkyl, substituted or unsubstituted C₃-C₆ branched alkyl, C₁ alkyl, C₂ alkyl, C₃ alkyl, C₄ alkyl, C₅ alkyl, C₆ alkyl, aryl, and phenyl.

In some embodiments, R₂₃ and R₂₄ are each individually selected from the group consisting of substituted or unsubstituted C₁-C₆ linear alkyl, substituted or unsubstituted C₃-C₆ branched alkyl, C₁ alkyl, C₂ alkyl, C₃ alkyl, C₄ alkyl, C₅ alkyl, and C₆ alkyl, preferably C₁-C₆ linear alkyl.

In some embodiments, R₂₃ is C₁ alkyl.

In some embodiments, R₂₄ is C₁ alkyl, C₂ alkyl, C₃ alkyl, C₄ alkyl, C₅ alkyl, C₆ alkyl, aryl, or phenyl.

In some embodiments, the silane is

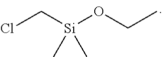

In some embodiments, the silane is

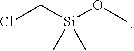

In many embodiments, reacting 114 the mixture in a first reaction may occur under any suitable reaction conditions known in the art that facilitates the method described herein. In some embodiments, reacting 114 the mixture in a first reaction includes stirring the mixture.

In many embodiments, reacting 114 the mixture in a first reaction may occur for any suitable amount of time known in the art that facilitates the method described herein. In some embodiments, the mixture is reacted 114 in a first reaction for an elapsed time in a range of from about 1 second to about 12 hours. In some embodiments, the mixture is reacted 114 in a first reaction for an elapsed time in a range of from about 1 second to about 6 hours. In some embodiments, the mixture is reacted 114 in a first reaction for an elapsed time in a range of from about 1 second to about 3 hours. In some embodiments, the mixture is reacted 114 in a first reaction for an elapsed time in a range of from about 1 hour to about 3 hours. In some embodiments, the mixture is reacted 114 in a first reaction for an elapsed time in a range of from about 2 hours to about 3 hours.

In some embodiments, reacting 114 the mixture in a first reaction includes adding the silane (e.g. chloromethyldimethylethoxysilane) dropwise over about 1 hour to the neat di- or polyamine containing at least one primary amine group. The reaction temperature is allowed to increase due to the reaction exotherm to about 90° C. and is retained at this temperature for the duration of the reaction (about 2-3 hours total). During this time, an HCl salt of the amine forms and may precipitate to varying degrees depending on the amine.

In some embodiments, the hydrolysis agent is added 116 dropwise to the mixture. In some embodiments, the hydrolysis agent is added to the mixture over a time period. In some embodiments, the hydrolysis agent is added 116 to the mixture over a time period in a range of from about 1 second to about 12 hours. In some embodiments, the hydrolysis agent is added 116 over 30 minutes and exothermic conditions and allowed to cool to room temperature prior to reacting 118 the mixture in a second reaction.

In some embodiments, the hydrolysis agent is added 116 over 30 minutes and exothermic conditions before reacting 118 the mixture in a second reaction. In these embodiments, the reacting 118 is complete before the reaction mixture is allowed to cool to room temperature.

In many embodiments, the hydrolysis agent may be any suitable hydrolysis agent known in the art that facilitates the method described herein. In some embodiments, the hydrolysis agent is an aqueous solution. In some embodiments, the hydrolysis agent is water.

In many embodiments, reacting 118 the mixture in a second reaction may occur under any suitable reaction conditions known in the art that facilitates the method described herein. In some embodiments, reacting 118 the mixture in a second reaction includes adjusting a temperature of the mixture. In some embodiments, reacting 118 the mixture in a second reaction includes cooling the mixture.

In some embodiments, the aminoalkyl-substituted disiloxane is further extracted from the reaction mixture. In some embodiments, the aminoalkyl-substituted disiloxane is further extracted from the reaction mixture with an organic solvent.

In some embodiments, extracting the aminoalkyl-substituted disiloxane from the reaction mixture includes adding an organic solvent (e.g chloroform and/or toluene) to the reaction mixture dropwise over 30 min and stirring the reaction mixture vigorously for about 1 hour or until cooled to room temperature. Once cool, the organic layer is isolated, the aqueous layer is back-extracted with minimal organic solvent, and the combined organic layers are concentrated under vacuum, triturated with organic solvent once and then dried under vacuum.

In some embodiments, the aminoalkyl-substituted disiloxane is further purified. In some embodiments, the further purification includes using distillation, vacuum distillation, and/or heat. In some embodiments, the further purification includes using vacuum distillation to remove impurities and byproducts. In these embodiments, the remaining material in the distillation pot is a product of higher purity relative to the product before purification.

In many embodiments, reacting 118 the mixture in a second reaction may occur for any suitable amount of time known in the art that facilitates the method described herein. In some embodiments, the mixture is reacted 118 in a second reaction for an elapsed time in a range of from about 1 second to about 12 hours. In some embodiments, the mixture is reacted 118 in a second reaction for an elapsed time in a range of from about 1 second to about 6 hours. In some embodiments, the mixture is reacted 118 in a second reaction for an elapsed time in a range of from about 1 second to about 3 hours. In some embodiments, the mixture is reacted 118 in a second reaction for an elapsed time in a range of from about 1 hour to about 3 hours. In some embodiments, the mixture is reacted 118 in a second reaction for an elapsed time in a range of from about 2 hours to about 3 hours.

In many embodiments, the method may also include any further suitable processing steps known in the art that facilitate the success of the method described herein. Such processing steps may include, but are not limited to only including, washing, drying, filtering, purifying, separating, centrifuging, and any combinations thereof. In some embodiments, the method further includes washing the aminoalkyl-substituted disiloxane compound. In some embodiments, the method further includes purifying the aminoalkyl-substituted disiloxane compound. In some embodiments, the purifying includes using distillation, vacuum distillation, and/or heat. In some embodiments, the method further includes removing a volatile reaction byproduct.

In some embodiments, the method includes: I) forming a mixture including: a di- or polyamine containing at least one primary amine group; and a choloromethyldimethylalkoxysilane; II) reacting the mixture, by nature of controlled exotherm, in a first reaction; III) adding a hydrolysis agent to the mixture; IV) reacting the mixture in a second reaction to form an aminoalkyl-substituted disiloxane; (V) extracting the aminoalkyl-substituted disiloxane; and (VI) purifying the aminoalkyl-substituted disiloxane.

In many embodiments, the aminoalkyl-substituted disiloxane may be used according to any suitable purpose known in the art. In some embodiments, the aminoalkyl-substituted disiloxane is used in a carbon capture system. In some embodiments, the aminoalkyl-substituted disiloxane is used in an aminosilicone-based product.

Further aspects of the present disclosure are provided by the subject matter of the following clauses:

1. A method of preparing an aminoalkyl-substituted disiloxane, the method comprising: I) forming a mixture comprising: a di- or polyamine containing at least one primary amine group; and a silane; II) reacting the mixture in a first reaction; III) adding a hydrolysis agent to the mixture; and IV) reacting the mixture in a second reaction to form the aminoalkyl-substituted disiloxane.

2. The method in accordance with the preceding clause, wherein the aminoalkyl-substituted disiloxane is a compound of Formula (I)

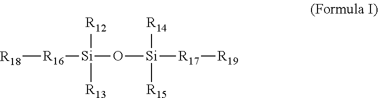

wherein:
R₁₂, R₁₃, R₁₄, R₁₅, are each individually selected from the group consisting of hydrogen, substituted or unsubstituted linear alkyl, substituted or unsubstituted C₁-C₆ linear alkyl, substituted or unsubstituted branched alkyl, substituted or unsubstituted C₃-C₆ branched alkyl, substituted or unsubstituted linear heteroalkyl, substituted or unsubstituted branched heteroalkyl, aryl, phenyl, heteroaryl, methyl, ethyl, propyl, isopropyl, butyl, pentyl, and hexyl;
R₁₆ and R₁₇ are each individually selected from the group consisting of direct bonds, substituted or unsubstituted C₁-C₆ linear alkyl, substituted or unsubstituted C₃-C₆ branched alkyl, C₁ alkyl, C₂ alkyl, C₃ alkyl, C₄ alkyl, C₅ alkyl, and C₆ alkyl;

R₁₈ and R₁₉ are each individually selected from the group consisting of substituents of Formula (IV)

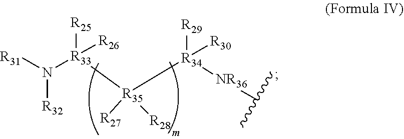

wherein:
the wavy bond indicates a bonding location to Formula (I);
R₂₅, R₂₆, R₂₇, R₂₈, R₂₉, and R₃₀ are each individually selected from the group consisting of hydrogen, substituted or unsubstituted linear alkyl, substituted or unsubstituted C₁-C₆ linear alkyl, substituted or unsubstituted branched alkyl, substituted or unsubstituted C₃-C₆ branched alkyl, substituted or unsubstituted linear heteroalkyl, substituted or unsubstituted C₁-C₆ linear heteroalkyl, substituted or unsubstituted branched heteroalkyl, substituted or unsubstituted C₃-C₆ branched heteroalkyl, aryl, heteroaryl, methyl, ethyl, propyl, isopropyl, butyl, pentyl, and hexyl;
R₃₁ and R₃₂ are each individually selected from the group consisting of hydrogen, substituted or unsubstituted linear alkyl, substituted or unsubstituted C₁-C₆ linear alkyl, substituted or unsubstituted C₁-C₃ linear alkyl, substituted or unsubstituted branched alkyl, substituted or unsubstituted C₃-C₆ branched alkyl, methyl, ethyl, propyl, substituted or unsubstituted cycloalkyl, substituted or unsubstituted C₃-C₆ cycloalkyl, and substituted or unsubstituted C₄-C₆ cycloalkyl, or, when taken together, R₃₁ and R₃₂ form a single ring selected from the group consisting of heterocycloalkyl or heteroaryl;
R₃₃, R₃₄, and R₃₅ are each individually selected from the group consisting of direct bonds, substituted or unsubstituted C₁-C₆ linear alkyl, substituted or unsubstituted C₃-C₆ branched alkyl, CI alkyl, C₂ alkyl, C₃ alkyl, C₄ alkyl, C₅ alkyl, C₆ alkyl, ether, —OCH₂CH₂—, —OCH₂CH₂CH₂—, —OCH₂CH₂CH₂CH₂—, —NHCH₂CH₂—, —NHCH₂CH₂CH₂—, and —NHCH₂CH₂CH₂CH₂—;
R₃₆ is selected from the group consisting of hydrogen, substituted or unsubstituted linear alkyl, substituted or unsubstituted C₁-C₆ linear alkyl, substituted or unsubstituted C₁-C₃ linear alkyl, substituted or unsubstituted branched alkyl, substituted or unsubstituted C₃-C₆ branched alkyl, methyl, ethyl, propyl, substituted or unsubstituted cycloalkyl, substituted or unsubstituted C₃-C₆ cycloalkyl, substituted or unsubstituted C₄-C₆ cycloalkyl, heterocycloalkyl, and heteroaryl; and
m is an integer in a range of 0 to 20.

3. The method in accordance with any preceding clause, wherein the aminoalkyl-substituted disiloxane is a compound selected from the group consisting of

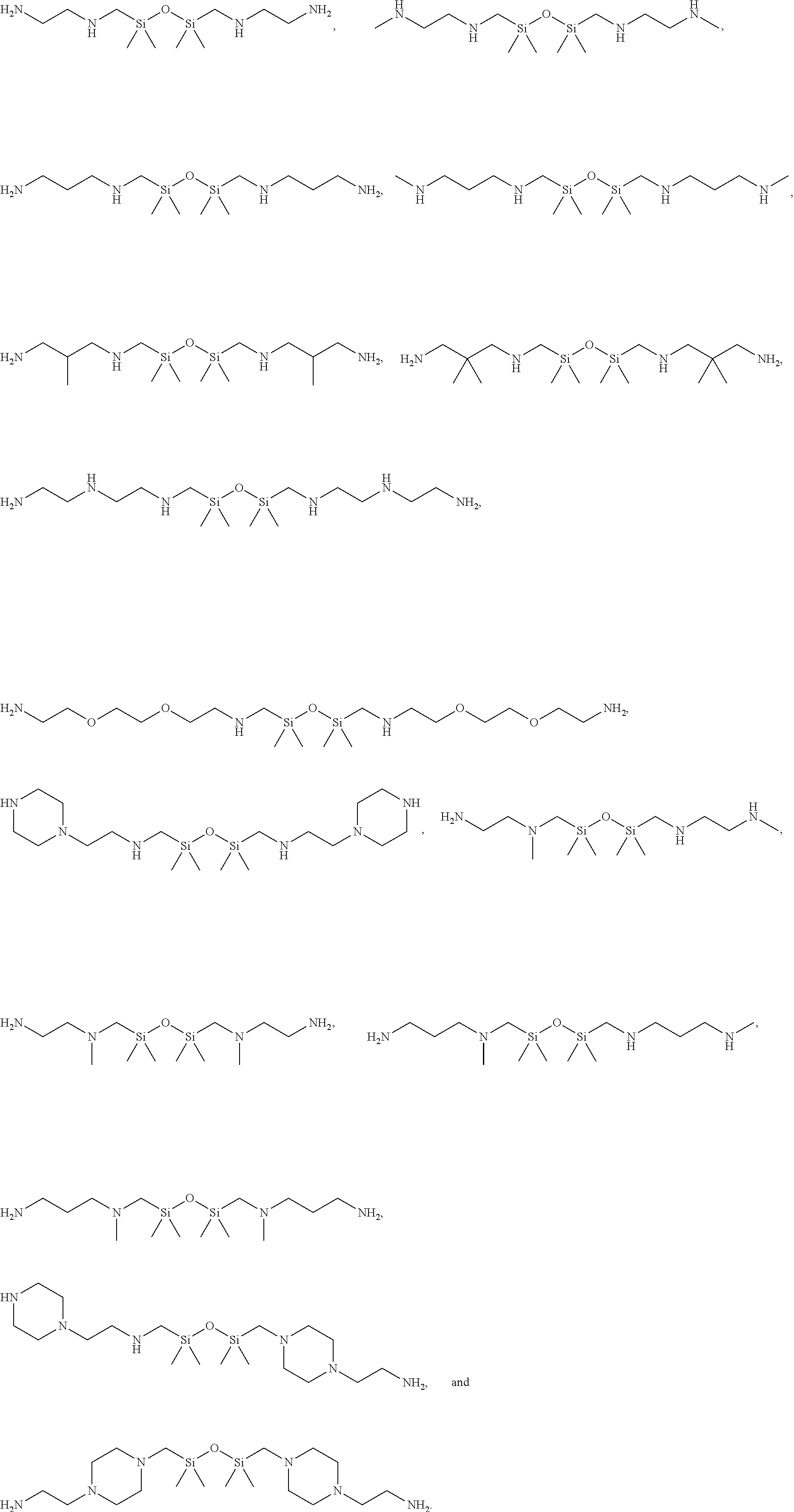

4. The method in accordance with any preceding clause, wherein the di- or polyamine containing at least one primary amine group is a compound of Formula (II)

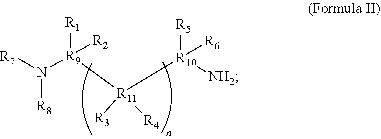

wherein:
R₁, R₂, R₃, R₄, R₅, and R₆ are each individually selected from the group consisting of hydrogen, substituted or unsubstituted linear alkyl, substituted or unsubstituted C₁-C₆ linear alkyl, substituted or unsubstituted branched alkyl, substituted or unsubstituted C₃-C₆ branched alkyl, substituted or unsubstituted linear heteroalkyl, substituted or unsubstituted branched heteroalkyl, substituted or unsubstituted C₃-C₆ branched heteroalkyl, aryl, phenyl, heteroaryl, methyl, ethyl, propyl, isopropyl, butyl, pentyl, and hexyl;
R₇ and R⁸ are each individually selected from the group consisting of hydrogen, substituted or unsubstituted linear alkyl, substituted or unsubstituted C₁-C₆ linear alkyl, substituted or unsubstituted C₁-C₃ linear alkyl, substituted or unsubstituted branched alkyl, substituted or unsubstituted C₃-C₆ branched alkyl, methyl, ethyl, propyl, substituted or unsubstituted cycloalkyl, substituted or unsubstituted C₃-C₆ cycloalkyl, and substituted or unsubstituted C₄-C₆ cycloalkyl, or, when taken together, R₇ and R₈ form a single ring selected from the group consisting of heterocycloalkyl or heteroaryl;
R₉, R₁₀, and R₁₁ are each individually selected from the group consisting of direct bonds, substituted or unsubstituted C₁-C₆ linear alkyl, substituted or unsubstituted C₃-C₆ branched alkyl, C₁ alkyl, C₂ alkyl, C₃ alkyl, C₄ alkyl, C₅ alkyl, C₆ alkyl, ether, —OCH₂CH₂—, —OCH₂CH₂CH₂—, —OCH₂CH₂CH₂CH₂—, —NHCH₂CH₂—, —NHCH₂CH₂CH₂—, and —NHCH₂CH₂CH₂CH₂—; and
n is an integer in a range of 0 to 20.

5. The method in accordance with any preceding clause, wherein the silane is a compound of Formula (III)

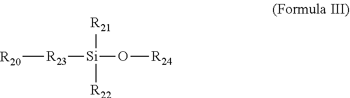

wherein:
R₂₀ is selected from the group consisting of halide, fluoride, chloride, bromide, and iodide;
R₂₁ and R₂₂ are each individually selected from the group consisting of hydrogen, substituted or unsubstituted linear alkyl, substituted or unsubstituted C₁-C₆ linear alkyl, substituted or unsubstituted branched alkyl, substituted or unsubstituted C₃-C₆ branched alkyl, substituted or unsubstituted linear heteroalkyl, substituted or unsubstituted branched heteroalkyl, aryl, phenyl, heteroaryl, methyl, ethyl, propyl, isopropyl, butyl, pentyl, and hexyl;
R₂₃ and R₂₄ are each individually selected from the group consisting of substituted or unsubstituted C₁-C₆ linear alkyl, substituted or unsubstituted C₃-C₆ branched alkyl, C₁ alkyl, C₂ alkyl, C₃ alkyl, C₄ alkyl, C₅ alkyl, C₆ alkyl, aryl, and phenyl.

6. The method in accordance with any preceding clause, wherein the silane is

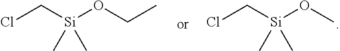

7. The method in accordance with any preceding clause, wherein reacting the mixture in a first reaction comprises stirring the mixture.

8. The method in accordance with any preceding clause, wherein reacting the mixture in a first reaction comprises reacting the mixture for a first time period.

9. The method in accordance with any preceding clause, wherein the first time period is a time in a range of from about 1 second to about 12 hours.

10. The method in accordance with any preceding clause, wherein the hydrolysis agent is an aqueous solution.

11. The method in accordance with any preceding clause, wherein the hydrolysis agent is water.

12. The method in accordance with any preceding clause, wherein the hydrolysis agent is added to the mixture over a second time period.

13. The method in accordance with any preceding clause, wherein the second time period is a time in a range of from about 1 second to about 12 hours.

14. The method in accordance with any preceding clause, wherein the hydrolysis agent is added dropwise to the mixture.

15. The method in accordance with any preceding clause, wherein the method further comprises purifying the aminoalkyl-substituted disiloxane.

16. The method in accordance with any preceding clause, wherein at least one method step comprises adjusting a temperature of the mixture.

17. The method in accordance with any preceding clause, wherein reacting the mixture in a second reaction comprises adjusting a temperature of the mixture.

18. The method in accordance with any preceding clause, wherein reacting the mixture in a second reaction comprises cooling the mixture.

19. The method in accordance with any preceding clause, wherein the method is a one-pot synthesis.

20. An aminoalkyl-substituted disiloxane prepared by the method in accordance with any preceding clause.

21. An aminoalkyl-substituted disiloxane of Formula (I)

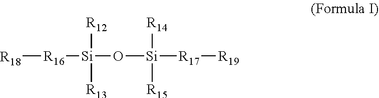

wherein:
R₁₂, R₁₃, R₁₄, R₁₅, are each individually selected from the group consisting of hydrogen, substituted or unsubstituted linear alkyl, substituted or unsubstituted C₁-C₆ linear alkyl, substituted or unsubstituted branched alkyl, substituted or unsubstituted C₃-C₆ branched alkyl, substituted or unsubstituted linear heteroalkyl, substituted or unsubstituted branched heteroalkyl, aryl, phenyl, heteroaryl, methyl, ethyl, propyl, isopropyl, butyl, pentyl, and hexyl;
R₁₆ and R₁₇ are each individually selected from the group consisting of direct bonds, substituted or unsubstituted C₁-C₆ linear alkyl, substituted or unsubstituted C₃-C₆ branched alkyl, C₁ alkyl, C₂ alkyl, C₃ alkyl, C₄ alkyl, C₅ alkyl, and C₆ alkyl;
R₁₈ and R₁₉ are each individually selected from the group consisting of substituents of Formula (IV)

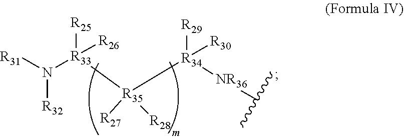

wherein:
the wavy bond indicates a bonding location to Formula (I);
R₂₅, R₂₆, R₂₇, R₂₈, R₂₉, and R₃₀ are each individually selected from the group consisting of hydrogen, substituted or unsubstituted linear alkyl, substituted or unsubstituted C₁-C₆ linear alkyl, substituted or unsubstituted branched alkyl, substituted or unsubstituted C₃-C₆ branched alkyl, substituted or unsubstituted linear heteroalkyl, substituted or unsubstituted C₁-C₆ linear heteroalkyl, substituted or unsubstituted branched heteroalkyl, substituted or unsubstituted C₃-C₆ branched heteroalkyl, aryl, heteroaryl, methyl, ethyl, propyl, isopropyl, butyl, pentyl, and hexyl;
R₃₁ and R₃₂ are each individually selected from the group consisting of hydrogen, substituted or unsubstituted linear alkyl, substituted or unsubstituted C₁-C₆ linear alkyl, substituted or unsubstituted C₁-C₃ linear alkyl, substituted or unsubstituted branched alkyl, substituted or unsubstituted C₃-C₆ branched alkyl, methyl, ethyl, propyl, substituted or unsubstituted cycloalkyl, substituted or unsubstituted C₃-C₆ cycloalkyl, and substituted or unsubstituted C₄-C₆ cycloalkyl, or, when taken together, R₃₁ and R₃₂ form a single ring selected from the group consisting of heterocycloalkyl or heteroaryl;
R₃₃, R₃₄, and R₃₅ are each individually selected from the group consisting of direct bonds, substituted or unsubstituted C₁-C₆ linear alkyl, substituted or unsubstituted C₃-C₆ branched alkyl, C₁ alkyl, C₂ alkyl, C₃ alkyl, C₄ alkyl, C₅ alkyl, C₆ alkyl, ether, —OCH₂CH₂—, —OCH₂CH₂CH₂—, —OCH₂CH₂CH₂CH₂—, —NHCH₂CH₂—, —NHCH₂CH₂CH₂—, and —NHCH₂CH₂CH₂CH₂—;
R₃₆ is selected from the group consisting of hydrogen, substituted or unsubstituted linear alkyl, substituted or unsubstituted C₁-C₆ linear alkyl, substituted or unsubstituted C₁-C₃ linear alkyl, substituted or unsubstituted branched alkyl, substituted or unsubstituted C₃-C₆ branched alkyl, methyl, ethyl, propyl, substituted or unsubstituted cycloalkyl, substituted or unsubstituted C₃-C₆ cycloalkyl, substituted or unsubstituted C₄-C₆ cycloalkyl, heterocycloalkyl, and heteroaryl; and
m is an integer in a range of 0 to 20;
provided that the aminoalkyl-substituted disiloxane is not

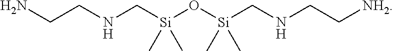 [SMILES: C[Si](C)(CNCCN)O[Si](C)(C)CNCCN]

22. The aminoalkyl-substituted disiloxane in accordance with the preceding clause, wherein the aminoalkyl-substituted disiloxane is a compound selected from the group consisting of

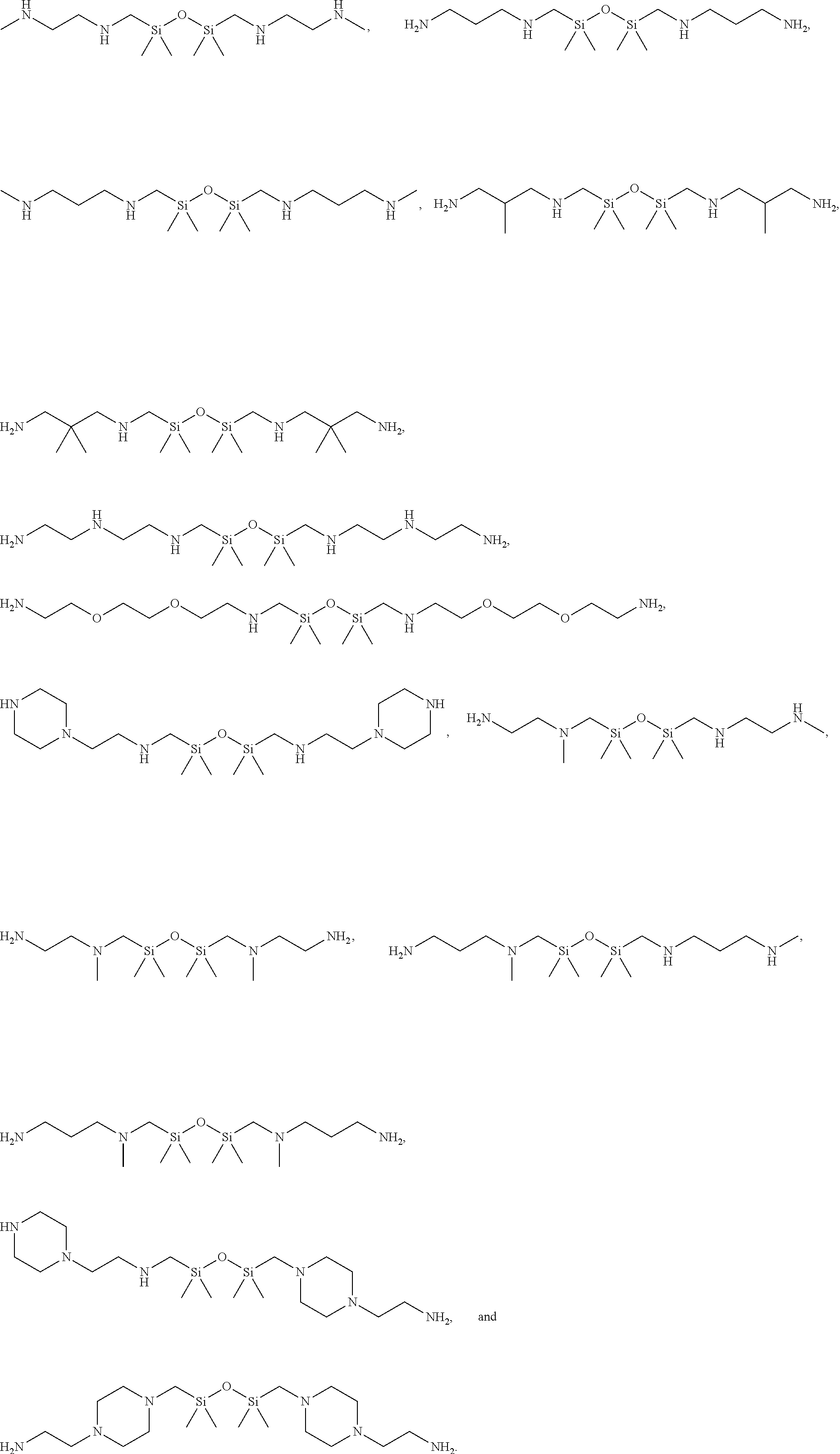

References to “some embodiments” in the above description are not intended to be interpreted as excluding the existence of additional embodiments that also incorporate the recited features.

### EXAMPLES

Without further elaboration, it is believed that one skilled in the art using the preceding description can utilize the present invention to its fullest extent. The following Examples are, therefore, to be construed as merely illustrative, and not limiting of the disclosure in any way whatsoever. The starting material for the following Examples may not have necessarily been prepared by a particular preparative run whose procedure is described in other Examples. It also is understood that any numerical range recited herein includes all values from the lower value to the upper value. For example, if a range is stated as 10-50, it is intended that values such as 12-30, 20-40, or 30-50, etc., are expressly enumerated in this specification. These are only examples of what is specifically intended, and all possible combinations of numerical values between and including the lowest value and the highest value enumerated are to be considered to be expressly stated in this application.

Example 1. Synthesis of aminomethyl-substituted disiloxane 1,3-bis(2-aminoethylaminomethyl)tetramethyldisiloxane with 4 eq. ethylenediamine.

Ethylenediamine (396 mL, 5.93 mol) was added to a 2 L 3 neck round bottomed flask fitted with an addition funnel and reflux condenser. The flask was placed in an ice water bath and the head space was purged with N₂. Chloromethyldimethylethoxysilane (240 mL, 1.48 mol) was added to the addition funnel and added dropwise to the ethylenediamine over 1 hour during which the reaction exotherms to 90-100° C. After an additional 1 hour the reaction was judged complete by ¹H NMR at which point 300 mL of water was added dropwise to the reaction mixture over 30 minutes, resulting in an exotherm. The reaction mixture was allowed to cool to room temperature while stirring at which point 300 mL of chloroform was added dropwise. The resulting mixture was stirred vigorously for 1 hour after which the organic layer was isolated and the aqueous layer was extracted with a minimum volume of chloroform. The combined organic layers were dried under reduced pressure at room temperature. The resulting material was then purified by vacuum distillation. A first fraction was collected over 40-80° C. and 380 mTorr containing primarily cyclic byproduct and some product. The remaining material (167 g, 81% yield) was deemed to be >75% pure by ¹H NMR spectroscopy. ¹H NMR (CDCl₃) δ: 2.80 (t, 4H, H₂NCH₂CH₂), 2.65 (t, 4H, H₂NCH₂), 2.05 (s, 4H, SiCH₂), 1.30 (br s, 6H, NH & NH₂), 0.12 (s, 12H, SiCH₃).

Example 2. Synthesis of aminomethyl-substituted disiloxane 1,3-bis(3-aminopropylaminomethyl)tetramethyldisiloxane.

The same procedure for Example 1 was followed but in a 250 mL 3 neck flask using 1,3-propanediamine (52 mL, 0.62 mol), chloromethyldimethylethoxysilane (25 mL, 0.15 mol), 40 mL of water, and 40 mL of chloroform. The resulting material was then purified by vacuum distillation. A first fraction was collected over 40-65° C. containing primarily cyclic byproduct and some product. The remaining material (17.6 g, 74% yield) was deemed to be >95% pure by ¹H NMR spectroscopy. ¹H NMR (CDCl₃) δ: 2.75 (t, 4H, H₂NCH₂CH₂CH₂), 2.65 (t, 4H, H₂NCH₂), 2.05 (s, 4H, SiCH₂), 1.60 (mult, 4H, H₂NCH₂CH₂), 1.30 (br s, 6H, NH & NH₂), 0.12 (s, 12H, SiCH₃).

Example 3. Synthesis of aminomethyl-substituted disiloxane 1,3-bis(2-methyl-3-aminopropylaminomethyl)tetramethyldisiloxane.

The same procedure for Example 1 was followed but in a 15 mL flask using 2-methyl-1,3-propanediamine (2.84 mL, 0.028 mol), chloromethyldimethylethoxysilane (1.14 mL, 0.0071 mol), 2 mL of water, and 2 mL of chloroform. The resulting material was then purified by vacuum distillation. A first fraction was collected at 110° C. containing byproduct and some product. The remaining material (0.60 g, 51% yield) was deemed to be >95% pure by ¹H NMR spectroscopy. ¹H NMR (CDCl₃) δ: 2.8-2.5 (overlapping mult, 8H, H₂NCH₂CH(CH₃)CH₂), 2.05 (mult, 4H, SiCH₂), 1.75 (mult, 2H, H₂NCH₂CH), 1.95 (br s, 6H, NH & NH₂), 0.90 (d, 6H, H₂NCH₂CHCH₃) 0.12 (s, 12H, SiCH₃).

Example 4. Synthesis of aminomethyl-substituted disiloxane 1,3-bis(2,2-dimethyl-3-aminopropylaminomethyl)tetramethyldisiloxane.

The same procedure for Example 1 was followed but in a 15 mL flask using 2,2-dimethyl-1,3-propanediamine (3.41 mL, 0.028 mol), chloromethyldimethylethoxysilane (1.12 mL, 0.0071 mol), 2 mL of water, and 2 mL of chloroform. The resulting material was then purified by vacuum distillation. A first fraction was collected at 80-90° ° C. containing byproduct and some product. The remaining material (0.95 g, 74% yield) was deemed to be >95% pure by ¹H NMR spectroscopy. ¹H NMR (CDCl₃) δ: 3.10 (br s, 6H, NH & NH₂), 2.67 (s, 4H, H₂NCH₂), 2.60 (s, 4H, H₂NCH₂C(CH₃)₂CH₂), 2.15 (s, 4H, SiCH₂), 0.95 (s, 12H, H₂NCH₂C(CH₃)₂), 0.19 (s, 12H, SiCH₃).

Example 5. Synthesis of aminomethyl-substituted disiloxane 1,3-bis(2-aminoethylaminomethyl)tetramethyldisiloxane with 8 eq. ethylenediamine.

Ethylenediamine (793 mL, 11.9 mol) was added to a 2 L 3 neck round bottomed flask fitted with an addition funnel and reflux condenser. The flask was placed in an ice water bath and the head space was purged with N₂. Chloromethyldimethylethoxysilane (240 mL, 1.48 mol) was added to the addition funnel and added dropwise to the ethylenediamine over 1 hour during which the reaction exotherms to 90-100° C. After an additional 1 hour the reaction was judged complete by ¹H NMR at which point 300 mL of water was added dropwise to the reaction mixture over 30 minutes, resulting in an exotherm. The reaction mixture was allowed to cool to room temperature while stirring at which point 300 mL of chloroform was added dropwise. The resulting mixture was stirred vigorously for 1 hour after which the organic layer was isolated, and the aqueous layer was extracted with a minimum volume of chloroform. The combined organic layers were dried under reduced pressure at room temperature. The resulting material was then purified by vacuum distillation. A first fraction was collected over 40-80° C. and 380 mTorr containing primarily cyclic byproduct and some product. The remaining material (326 g, 79% yield) was deemed to be >90% pure by ¹H NMR spectroscopy. ¹H NMR (CDCl₃) δ: 2.80 (t, 4H, H₂NCH₂CH₂), 2.65 (t, 4H, H₂NCH₂), 2.05 (s, 4H, SiCH₂), 1.30 (br s, 6H, NH & NH₂), 0.12 (s, 12H, SiCH₃).

Example 6. Synthesis of aminomethyl-substituted disiloxane 1,3-bis(2-aminoethylaminomethyl)tetramethyldisiloxane with 10 eq. ethylenediamine.

Ethylenediamine (400 mL, 5.99 mol) was added to a 2 L 3 neck round bottomed flask fitted with an addition funnel and reflux condenser. The flask was placed in an ice water bath and the head space was purged with N₂. Chloromethyldimethylethoxysilane (97 mL, 0.59 mol) was added to the addition funnel and added dropwise to the ethylenediamine over 1 hour during which the reaction exotherms to 90-100° C. After an additional 1 hour the reaction was judged complete by ¹H NMR at which point 300 mL of water was added dropwise to the reaction mixture over 30 minutes, resulting in an exotherm. The reaction mixture was allowed to cool to room temperature while stirring at which point 300 mL of chloroform was added dropwise. The resulting mixture was stirred vigorously for 1 hour after which the organic layer was isolated, and the aqueous layer was extracted with a minimum volume of chloroform. The combined organic layers were dried under reduced pressure at room temperature. The resulting material was then purified by vacuum distillation. A first fraction was collected over 40-80° C. and 380 mTorr containing primarily cyclic byproduct and some product. The remaining material (117 g, 70% yield) was deemed to be >95% pure by ¹H NMR spectroscopy. ¹H NMR (CDCl₃) δ: 2.80 (t, 4H, H₂NCH₂CH₂), 2.65 (t, 4H, H₂NCH₂), 2.05 (s, 4H, SiCH₂), 1.30 (br s, 6H, NH & NH₂), 0.12 (s, 12H, SiCH₃).

Comparative Example 1. Attempted synthesis of aminomethyl-substituted disiloxane 1,3-bis(2-aminoethylaminomethyl)tetramethyldisiloxane from 1,3-bis(chloromethyl)tetramethyldisiloxane.

Ethylenediamine (13 g, 0.216 mol, 10 equiv) was added to a 50 ml 3-neck round bottom flask equipped with a nitrogen blanket, magnetic stir bar, condenser, and an addition funnel. It was then heated to an oil set of 110° C. in an oil bath. Once the temperature in the oil bath stabilized 1,3-bis(chloromethyl)-1,1,3,3-tetramethyldisiloxane (5 g, 0.0216 mol) was added dropwise over a 2 hour period. The reaction was allowed to stir overnight at temperature. The reaction was cooled ¹H NMR analysis was performed to check that the reaction was complete. The reaction mixture was then poured into a 250 ml separatory funnel and partitioned between chloroform and 10% NaOH, washed 3 times with DI water, once with saturated sodium chloride then dried over anhydrous potassium chloride. After filtration the chloroform was stripped on a rotary evaporator yielding a clear, colorless viscous liquid. ¹H NMR analysis showed a mixture of products containing the cyclic byproduct 2,2,6,6-tetramethyl-1-oxa-4-aza-2,6-disilacyclohexane-4-ethanamine. The desired 1,3-bis(2-aminoethylaminomethyl)tetramethyldisiloxane was not formed.

Comparative Example 2. Attempted synthesis of aminomethyl-substituted disiloxane 1,3-bis(2-aminoethylaminomethyl)tetramethyldisiloxane from 1,3bis(iodomethyl)tetramethyldisiloxane.

Ethylenediamine (13 g, 0.216 mol, 10 equiv) was added to a 50 ml 3-neck round bottom flask equipped with a nitrogen blanket, magnetic stir bar, condenser, and an addition funnel. 1,3-bis(iodomethyl)-1,1,3,3-tetramethyldisiloxane (10.16 g, 0.0216 mol) was added dropwise over a 2 hour period. The reaction was allowed to stir overnight at room temperature. ¹H NMR analysis was performed to check that the reaction was complete. The reaction mixture was then poured into a 250 ml separatory funnel and partitioned between chloroform and 10% NaOH, washed 3 times with DI water, once with saturated sodium chloride then dried over anhydrous potassium chloride. After filtration the chloroform was stripped on a rotary evaporator yielding a clear, colorless viscous liquid. ¹H NMR analysis showed clean formation of the cyclic byproduct 2,2,6,6-tetramethyl-1-oxa-4-aza-2,6-disilacyclohexane-4-ethanamine. The desired 1,3-bis(2-aminoethylaminomethyl)tetramethyldisiloxane was not formed. ¹H NMR (CDCl₃) of 2,2,6,6-tetramethyl-1-oxa-4-aza-2,6-disilacyclohexane-4-ethanamine, δ: 2.70 (t, 2H, CH₂), 2.40 (t, 2H, CH₂), 1.75 (overlapping s, 4H+2H, SiCH₂NCH₂Si+H₂N), 0.10 (s, 12H, SiCH₃).

Unless otherwise indicated, approximating language, such as “generally,” “substantially,” and “about,” as used herein indicates that the term so modified may apply to only an approximate degree, as would be recognized by one of ordinary skill in the art, rather than to an absolute or perfect degree. Accordingly, a value modified by a term or terms such as “about,” “approximately,” and “substantially” is not to be limited to the precise value specified. In at least some instances, the approximating language may correspond to the precision of an instrument for measuring the value. Additionally, unless otherwise indicated, the terms “first,” “second,” etc. are used herein merely as labels, and are not intended to impose ordinal, positional, or hierarchical requirements on the items to which these terms refer. Moreover, reference to, for example, a “second” item does not require or preclude the existence of, for example, a “first” or lower-numbered item or a “third” or higher-numbered item.

Although specific features of various embodiments of the invention may be shown in some drawings and not in others, this is for convenience only. Moreover, references to “some embodiments” in the above description are not intended to be interpreted as excluding the existence of additional embodiments that also incorporate the recited features. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

It is readily understood by those skilled in the art that some substituents of the present disclosure depend on the presence of other substituents and are therefore optional. For example, in Formula II, when R₉ is a direct bond, R₁ and R₂ are optional substituents not present in the compound. Similarly, in Formula II, when n is 0, there is a direct bond between R₉ and R₁₀, and R₃, R₄, and R₁₁ are optional substituents not present in the compound. The optionality of a substituent in one embodiment is non-limiting regarding the presence of the substituent in another embodiment.

As used herein, the term “alkyl”, used either alone or in compound words such as “haloalkyl” includes straight-chain or branched alkyl such as methyl, ethyl, n-propyl and i-propyl, or the different butyl, pentyl or hexyl isomers. An alkyl defined by a number of carbon atoms, e.g. C₆ alkyl, is understood to have that many carbon atoms but is not otherwise limited.

As used herein, the term “heteroalkyl” denotes an alkyl chain wherein at least one of the atoms forming the chain backbone is other than carbon.

As used herein, “aminoalkyl” includes an N radical substituted with straight-chain or branched alkyl.

As used herein, the term “halogen” or “halide” either alone or in compound words such as “haloalkyl”, includes fluorine, chlorine, bromine or iodine. Further, when used in compound words such as “haloalkyl”, said alkyl may be partially or fully substituted with halogen atoms which may be the same or different. Examples of “haloalkyl” include F₃C, ClCH₂, CF₃CH₂ and CF₃CCl₂. The term “haloalkoxy”, and the like, are defined analogously to the term “haloalkyl”. Examples of “haloalkoxy” include CF₃O, CCl₃CH₂O, F₂CHCH₂CH₂O and CF₃CH₂O.

As used herein, the term “heterocycle” denotes a ring wherein at least one of the atoms forming the ring backbone is other than carbon. Unless otherwise indicated, a heterocycle can be a saturated, partially unsaturated, or fully unsaturated ring. When a fully unsaturated heterocyclic ring satisfies Hückel's rule, then said ring is also called a “heteroaryl” or aromatic heterocyclic ring. “Saturated heterocyclic ring” refers to a heterocyclic ring containing only single bonds between ring members.

What is claimed is:

1. A method of preparing an aminoalkyl-substituted disiloxane, the method comprising:
I) forming a mixture comprising:
a di- or polyamine containing at least one primary amine group; and
a silane;
II) reacting the mixture in a first reaction;
III) adding a hydrolysis agent to the mixture; and
IV) reacting the mixture in a second reaction to form the aminoalkyl-substituted disiloxane.

2. The method in accordance with claim 1, wherein the aminoalkyl-substituted disiloxane is a compound of Formula (I) 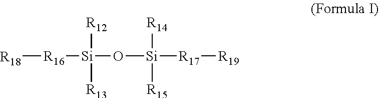
wherein:
R₁₂, R₁₃, R₁₄, R₁₅, are each individually selected from the group consisting of hydrogen, substituted or unsubstituted linear alkyl, substituted or unsubstituted C₁-C₆ linear alkyl, substituted or unsubstituted branched alkyl, substituted or unsubstituted C₃-C₆ branched alkyl, substituted or unsubstituted linear heteroalkyl, substituted or unsubstituted branched heteroalkyl, aryl, phenyl, heteroaryl, methyl, ethyl, propyl, isopropyl, butyl, pentyl, and hexyl;
R₁₆ and R₁₇ are each individually selected from the group consisting of direct bonds, substituted or unsubstituted C₁-C₆ linear alkyl, substituted or unsubstituted C₃-C₆ branched alkyl, C₁ alkyl, C₂ alkyl, C₃ alkyl, C₄ alkyl, C₅ alkyl, and C₆ alkyl;
R₁₈ and R₁₉ are each individually selected from the group consisting of substituents of Formula (IV) 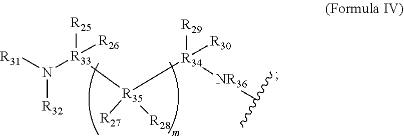
wherein:
the wavy bond indicates a bonding location to Formula (I);
R₂₅, R₂₆, R₂₇, R₂₈, R₂₉, and R₃₀ are each individually selected from the group consisting of hydrogen, substituted or unsubstituted linear alkyl, substituted or unsubstituted C₁-C₆ linear alkyl, substituted or unsubstituted branched alkyl, substituted or unsubstituted C₃-C₆ branched alkyl, substituted or unsubstituted linear heteroalkyl, substituted or unsubstituted C₁-C₆ linear heteroalkyl, substituted or unsubstituted branched heteroalkyl, substituted or unsubstituted C₃-C₆ branched heteroalkyl, aryl, heteroaryl, methyl, ethyl, propyl, isopropyl, butyl, pentyl, and hexyl;
R₃₁ and R₃₂ are each individually selected from the group consisting of hydrogen, substituted or unsubstituted linear alkyl, substituted or unsubstituted C₁-C₆ linear alkyl, substituted or unsubstituted C₁-C₃ linear alkyl, substituted or unsubstituted branched alkyl, substituted or unsubstituted C₃-C₆ branched alkyl, methyl, ethyl, propyl, substituted or unsubstituted cycloalkyl, substituted or unsubstituted C₃-C₆ cycloalkyl, and substituted or unsubstituted C₄-C₆ cycloalkyl, or, when taken together, R₃₁ and R₃₂ form a single ring selected from the group consisting of heterocycloalkyl or heteroaryl;
R₃₃, R₃₄, and R₃₅ are each individually selected from the group consisting of direct bonds, substituted or unsubstituted C₁-C₆ linear alkyl, substituted or unsubstituted C₃-C₆ branched alkyl, C₁ alkyl, C₂ alkyl, C₃ alkyl, C₄ alkyl, C₅ alkyl, C₆ alkyl, ether, —OCH₂CH₂—, —OCH₂CH₂CH₂—, —OCH₂CH₂CH₂CH₂—, —NHCH₂CH₂—, —NHCH₂CH₂CH₂—, and —NHCH₂CH₂CH₂CH₂—;
R₃₆ is selected from the group consisting of hydrogen, substituted or unsubstituted linear alkyl, substituted or unsubstituted C₁-C₆ linear alkyl, substituted or unsubstituted C₁-C₃ linear alkyl, substituted or unsubstituted branched alkyl, substituted or unsubstituted C₃-C₆ branched alkyl, methyl, ethyl, propyl, substituted or unsubstituted cycloalkyl, substituted or unsubstituted C₃-C₆ cycloalkyl, substituted or unsubstituted C₄-C₆ cycloalkyl, heterocycloalkyl, and heteroaryl; and
m is an integer in a range of 0 to 20.

3. The method in accordance with claim 1, wherein the aminoalkyl-substituted disiloxane is a compound selected from the group consisting of

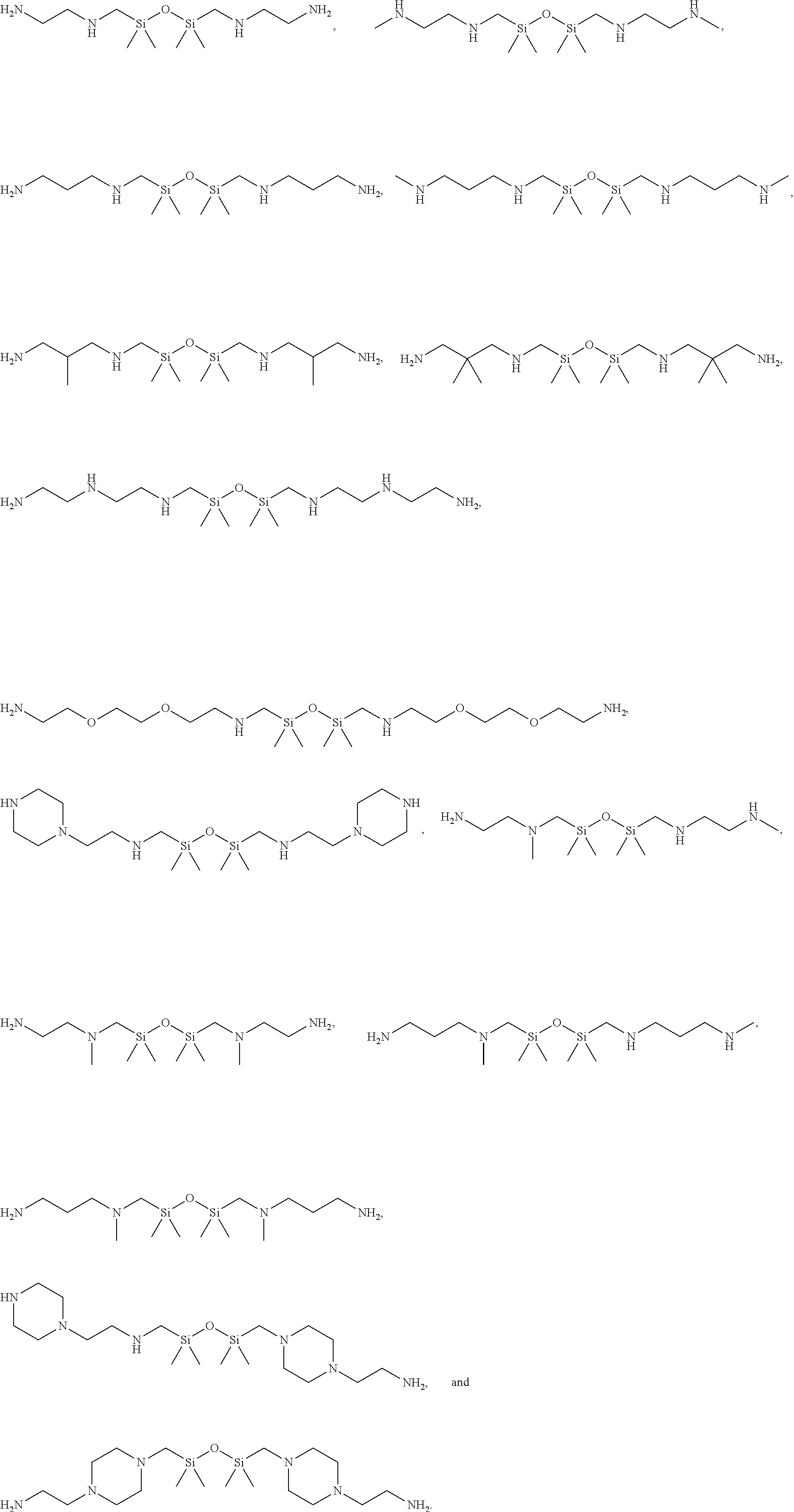

4. The method in accordance with claim 1, wherein the di- or polyamine containing at least one primary amine group is a compound of Formula (II) 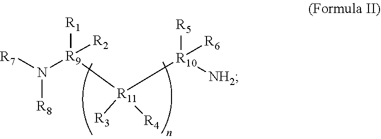
wherein:
R₁, R₂, R₃, R₄, R₅, and R₆ are each individually selected from the group consisting of hydrogen, substituted or unsubstituted linear alkyl, substituted or unsubstituted C₁-C₆ linear alkyl, substituted or unsubstituted branched alkyl, substituted or unsubstituted C₃-C₆ branched alkyl, substituted or unsubstituted linear heteroalkyl, substituted or unsubstituted branched heteroalkyl, substituted or unsubstituted C₃-C₆ branched heteroalkyl, aryl, phenyl, heteroaryl, methyl, ethyl, propyl, isopropyl, butyl, pentyl, and hexyl;
R₇ and R₈ are each individually selected from the group consisting of hydrogen, substituted or unsubstituted linear alkyl, substituted or unsubstituted C₁-C₆ linear alkyl, substituted or unsubstituted C₁-C₃ linear alkyl, substituted or unsubstituted branched alkyl, substituted or unsubstituted C₃-C₆ branched alkyl, methyl, ethyl, propyl, substituted or unsubstituted cycloalkyl, substituted or unsubstituted C₃-C₆ cycloalkyl, and substituted or unsubstituted C₄-C₆ cycloalkyl, or, when taken together, R₇ and R₈ form a single ring selected from the group consisting of heterocycloalkyl or heteroaryl;
R₉, R₁₀, and R₁₁ are each individually selected from the group consisting of direct bonds, substituted or unsubstituted C₁-C₆ linear alkyl, substituted or unsubstituted C₃-C₆ branched alkyl, C₁ alkyl, C₂ alkyl, C₃ alkyl, C₄ alkyl, C₅ alkyl, C₆ alkyl, ether, —OCH₂CH₂—, —OCH₂CH₂CH₂—, —OCH₂CH₂CH₂CH₂—, —NHCH₂CH₂—, —NHCH₂CH₂CH₂—, and —NHCH₂CH₂CH₂CH₂—; and
n is an integer in a range of 0 to 20.

5. The method in accordance with claim 1, wherein the silane is a compound of Formula (III) 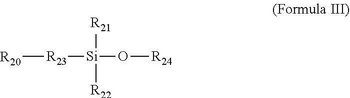
wherein:
R₂₀ is selected from the group consisting of halide, fluoride, chloride, bromide, and iodide;
R₂₁ and R₂₂ are each individually selected from the group consisting of hydrogen, substituted or unsubstituted linear alkyl, substituted or unsubstituted C₁-C₆ linear alkyl, substituted or unsubstituted branched alkyl, substituted or unsubstituted C₃-C₆ branched alkyl, substituted or unsubstituted linear heteroalkyl, substituted or unsubstituted branched heteroalkyl, aryl, phenyl, heteroaryl, methyl, ethyl, propyl, isopropyl, butyl, pentyl, and hexyl;
R₂₃ and R₂₄ are each individually selected from the group consisting of substituted or unsubstituted C₁-C₆ linear alkyl, substituted or unsubstituted C₃-C₆ branched alkyl, C₁ alkyl, C₂ alkyl, C₃ alkyl, C₄ alkyl, C₅ alkyl, C₆ alkyl, aryl, and phenyl.

6. The method in accordance with claim 1, wherein the silane is

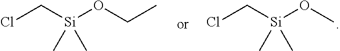

7. The method in accordance with claim 1, wherein reacting the mixture in a first reaction comprises stirring the mixture.

8. The method in accordance with claim 1, wherein reacting the mixture in a first reaction comprises reacting the mixture for a first time period.

9. The method in accordance with claim 8, wherein the first time period is a time in a range of from about 1 second to about 12 hours.

10. The method in accordance with claim 1, wherein the hydrolysis agent is an aqueous solution.

11. The method in accordance with claim 1, wherein the hydrolysis agent is water.

12. The method in accordance with claim 1, wherein the hydrolysis agent is added to the mixture over a second time period.

13. The method in accordance with claim 12, wherein the second time period is a time in a range of from about 1 second to about 12 hours.

14. The method in accordance with claim 1, wherein the hydrolysis agent is added dropwise to the mixture.

15. The method in accordance with claim 1, wherein the method further comprises purifying the aminoalkyl-substituted disiloxane.

16. The method in accordance with claim 1, wherein at least one method step comprises adjusting a temperature of the mixture.

17. The method in accordance with claim 1, wherein reacting the mixture in a second reaction comprises adjusting a temperature of the mixture.

18. The method in accordance with claim 1, wherein reacting the mixture in a second reaction comprises cooling the mixture.

19. The method in accordance with claim 1, wherein the method is a one-pot synthesis.

20. An aminoalkyl-substituted disiloxane prepared by the method in accordance with claim 1.

21. An aminoalkyl-substituted disiloxane of Formula (I) 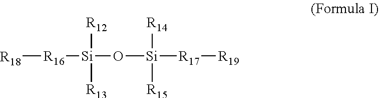
wherein:
R₁₂, R₁₃, R₁₄, R₁₅, are each individually selected from the group consisting of hydrogen, substituted or unsubstituted linear alkyl, substituted or unsubstituted C₁-C₆ linear alkyl, substituted or unsubstituted branched alkyl, substituted or unsubstituted C₃-C₆ branched alkyl, substituted or unsubstituted linear heteroalkyl, substituted or unsubstituted branched heteroalkyl, aryl, phenyl, heteroaryl, methyl, ethyl, propyl, isopropyl, butyl, pentyl, and hexyl;
R₁₆ and R₁₇ are each individually selected from the group consisting of direct bonds, substituted or unsubstituted C₁-C₆ linear alkyl, substituted or unsubstituted C₃-C₆ branched alkyl, C₁ alkyl, C₂ alkyl, C₃ alkyl, C₄ alkyl, C₅ alkyl, and C₆ alkyl;
R₁₈ and R₁₉ are each individually selected from the group consisting of substituents of Formula (IV) 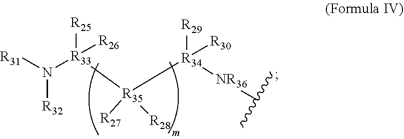
wherein:
the wavy bond indicates a bonding location to Formula (I);
R₂₅, R₂₆, R₂₇, R₂₈, R₂₉, and R₃₀ are each individually selected from the group consisting of hydrogen, substituted or unsubstituted linear alkyl, substituted or unsubstituted C₁-C₆ linear alkyl, substituted or unsubstituted branched alkyl, substituted or unsubstituted C₃-C₆ branched alkyl, substituted or unsubstituted linear heteroalkyl, substituted or unsubstituted C₁-C₆ linear heteroalkyl, substituted or unsubstituted branched heteroalkyl, substituted or unsubstituted C₃-C₆ branched heteroalkyl, aryl, heteroaryl, methyl, ethyl, propyl, isopropyl, butyl, pentyl, and hexyl;
R₃₁ and R₃₂ are each individually selected from the group consisting of hydrogen, substituted or unsubstituted linear alkyl, substituted or unsubstituted C₁-C₆ linear alkyl, substituted or unsubstituted C₁-C₃ linear alkyl, substituted or unsubstituted branched alkyl, substituted or unsubstituted C₃-C₆ branched alkyl, methyl, ethyl, propyl, substituted or unsubstituted cycloalkyl, substituted or unsubstituted C₃-C₆ cycloalkyl, and substituted or unsubstituted C₄-C₆ cycloalkyl, or, when taken together, R₃₁ and R₃₂ form a single ring selected from the group consisting of heterocycloalkyl or heteroaryl;
R₃₃, R₃₄, and R₃₅ are each individually selected from the group consisting of direct bonds, substituted or unsubstituted C₁-C₆ linear alkyl, substituted or unsubstituted C₃-C₆ branched alkyl, C₁ alkyl, C₂ alkyl, C₃ alkyl, C₄ alkyl, C₅ alkyl, C₆ alkyl, ether, —OCH₂CH₂—, —OCH₂CH₂CH₂—, —OCH₂CH₂CH₂CH₂—, —NHCH₂CH₂—, —NHCH₂CH₂CH₂—, and —NHCH₂CH₂CH₂CH₂—;
R₃₆ is selected from the group consisting of hydrogen, substituted or unsubstituted linear alkyl, substituted or unsubstituted C₁-C₆ linear alkyl, substituted or unsubstituted C₁-C₃ linear alkyl, substituted or unsubstituted branched alkyl, substituted or unsubstituted C₃-C₆ branched alkyl, methyl, ethyl, propyl, substituted or unsubstituted cycloalkyl, substituted or unsubstituted C₃-C₆ cycloalkyl, substituted or unsubstituted C₄-C₆ cycloalkyl, heterocycloalkyl, and heteroaryl; and
m is an integer in a range of 0 to 20;
provided that the aminoalkyl-substituted disiloxane is not

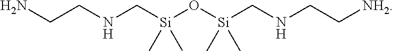 [SMILES: C[Si](C)(CNCCN)O[Si](C)(C)CNCCN]

22. The aminoalkyl-substituted disiloxane in accordance with claim 21, wherein the aminoalkyl-substituted disiloxane is a compound selected from the group consisting of [chemical structure]
